(19) United States
(12) Patent Application Publication
(10) Pub. No.: US 2005/0166462 A1
(43) Pub. Date: Aug. 4, 2005

(54) Door for motor vehicles

(76) Inventors: Alfred Losch, Tholey Hasborn (DE); Horst-Gunter Haupenthal, Hermeskeil (DE); Uwe Glasen, Freisen (DE)

Correspondence Address: MCGLEW & TUTTLE, PC, P.O. BOX 9227, SCARBOROUGH STATION, SCARBOROUGH, NY, 10510-9227, US

(21) Appl. No.: 10/500,611

(22) PCT Filed: Jan. 14, 2003
(86) PCT No.: PCT/EP03/00246

(30) Foreign Application Priority Data
Feb. 16, 2002 (DE) 102 06 513.6

(51) Int. Cl. B60J 5/04

(52) U.S. Cl. 49/502

(57) ABSTRACT

A door for motor vehicles has a door outer sheet, a door inner sheet, a closing sheet for the window frame and reinforcing sheets for example for lateral collision protection, for fastening the door hinges and for receiving the door units. The inventive door has an outer module (A) and an inner module (I). The outer module (A) includes the door outer sheet (1) and a connecting sheet (6) fastened on the inside thereof, the connecting sheet (6) being provided with integrated or retrofittable reinforcing elements (4 and 10) and carries the door hinges that can be detachably linked with the body. The inner module (I) includes a door inner sheet (2) and at least one closing sheet (3) linked therewith. The door inner sheet (2) and the closing sheet (3) enclose the window frame. The inner module (I) is provided with receiving possibilities for the door units such as for example window pane, window actuator, lateral airbag. The separating line between the outer module (A) and the inner module (I) extends along the sealing plane of the door-mounted door seal (7), and the outer module (A) and the inner module (I) are interlinked by screws or rivets or are glued together or the like.

### FIELD OF THE INVENTION

The present invention relates to a door for motor vehicles with a door outer metal plate and a door inner metal plate.

### BACKGROUND OF THE INVENTION

DE 199 57 986 A1 discloses a generic motor vehicle door comprised of an outer and inner module, with a first inner door module consisting of a door ring frame and a door box-type inner wall serving as module earner for attachment parts, and a second door module as door box-type outer wall consisting of a carrier part and an outer metal plate connected thereto.

Achieved with this door concept is a so-called three-level structure of the door comprised of a door outer metal plate serving as outer wall, a door ring frame made of aluminum, and a module earner serving as door box-type inner wall. The arrangement of the door seal is not addressed in this publication.

Known furthermore is a door carcass for a motor vehicle made in a self-carrying shell-type construction. With this door carcass, the outer skin and inner shell generally consist of steel or aluminum metal plates that are produced by deep-drawing technology. Generally applied as joining techniques are spot welding and/or edge-formed joining. A door body of the door carcass may be set-up with or without a window frame. In addition, several impact carriers may be integrated into the door body in order to provide for increased side crash protection.

The individual metal plate parts of a door for motor vehicles as illustrated in FIG. 7, representing the state of the art in technology and produced by forming are permanently joined to each other in conformity with a conventional concept and, after their attachment to the car body in the carcass, they are lacquered jointly with the car body. Subsequently, in a relatively costly procedure, the door-side seal is glued thereto. The installation of usual door aggregates into the lacquered door assembled to form a unit is problematic and feasibly only at substantial expenditure. When using dirt-repelling lacquers it became evident that the door seal can hardly or not at all be glued.

Known from DE 199 36 175 A1 is a door for a motor vehicle, which is comprised of a cocarrying metallic inner metal plate structure with a co-carrying outer skin made of fiber compound materials. Arranged in the outer skin is a highly solid and highly stiff frame providing strength adapted to crash requirements. Both the outer skin and inner shell are to be cladding and, in the sense of structural parts, non-carrying components which, however, provide bending strength sufficient for everyday and ordinary suitability. Overlapping rims are provided for detachable fixing of the inner shell and outer skin. The type of connecting the load-carrying structure with the inner shell and outer skin as well as the problem of door seals 5 are not addressed therein.

### SUMMARY OF THE INVENTION

Now, therefore, it is the objective and task of the present invention to provide a novel door and sealing concept in which the afore mentioned problems do not exist and in which assembly, in particular, is simplified and stiffness increased.

According to the present invention, the door is provided with an outer module and an inner module. The outer module is comprised of a door outer metal plate and a connecting metal plate affixed thereto inside, with the connecting metal plate carrying the door hinges that can be linked to the car body. Integrated therein may be the window shaft reinforcement and other reinforcement parts such as door hinge reinforcement and side impact protection. The inner module is comprised of a door inner metal plate and a locking metal plate connected thereto, with these two parts encompassing the window frame. The inner metal plate has a circumferential profiling to accommodate a door seal that can be plugged-on. Moreover, it may have appropriate means for accommodating the door aggregates, e.g. window panes, window handles, and a side airbag. The separating line between the outer module and inner module according to the present invention extends along the sealing level of the door-side door seal. After separate manufacture, particularly separate lacquering and outfit of the inner module with the door aggregates, the outer module and inner module according to the present invention can be connected with each other by screwing, riveting, gluing, or in a similar manner and, after attachment of the circumferential door seal, be affixed in exact position to the car body.

By dividing and/or separating a conventional inner metal plate (vide FIG. 7) into a connecting plate, which is connected to the door outer metal plate, and into an inner metal plate, which is connected to the locking plate and provides for means to accommodate the door aggregates, the use of specific materials such as high-strength steel, aluminum or tailored blanks and a combination of different materials thereof, too, is much easier to realize, because the metal plates are less strained in terms of forming technique due to the lesser drawing depth.

As a result of the novel modular door setup it is feasible to practically implement the strategy of buying complete doors from external sources, which is more and more desired by automobile manufacturers. By integrating certain reinforcement parts into the connecting plate of the outer module, the number of necessary metal plate parts can be reduced.

It turned out to be favorable to form a circumferential fixing profile for a door seal, which can be plugged on, at the inner plate, particularly by applying the deep-drawing technique. This fixing profile is preferably designed and constructed mainly like a U-shape in the cross-section and at its outer end, it has a short and mainly rectangular rim formed towards the interior to hold the door seal. The fixing profile affixed to the inner metal plate provides an alternative to the gluing of the door-side seal by plugging it on in a simple manner and retaining it lastingly. As compared with gluing, this type of sealing involves less cost of production and assembly. Moreover, when refraining from a glued-on door-side seal, it is also feasible to apply so-called dirt-repelling lacquers or similar lacquers, which do not permit gluing of the seal.

According to the present invention, a detachable screw or rivet connection is provided for, preferably by placing a supportive adhesive in between, which is arranged in the area of the rims of the connecting plate of the outer module and of the fixing profile at the door inner plate of the inner module. To this effect, the U-shaped fixing profile has a level and plane support surface at the basis.

By providing a detachable connection between the outer plate and the connecting plate within the outer module, it is also possible to implement a non-detachable connection between outer module and inner module. In that case, it would also be possible to implement the assembly line shown in FIG. 6, exchanging only the outer plate in case of a repair.

The individual parts of the inner and outer module can be permanently connected to each other, preferably by laser welding or soldering. This applies in particular to connecting the door inner plate with the locking plate and the reinforcing plate of the B-column. In a similar approach, it is also possible to connect the reinforcing parts with the connecting plate of the outer module and the connecting plate itself with the door outer plate. However, the connecting plate and the door outer plate can also be connected with each other by folding, gluing or similar techniques.

In summary, the novel door and sealing concept yields the following advantages as compared with those concepts representing state-of-art technology:
The door-side seal can simply be plugged-on as an extrudate.
The door aggregates are exclusively affixed to the inner module, thus being assembly-friendly.
The ready-assembled inner module, which is preferably lacquered separately from the outer module, can be screwed to the outer module that is lacquered jointly with the car body.
If the outer plate is additionally provided in detachable configuration, friendliness on repair and recycling will be greater.
With the inner plate extending across the entire sealing area, as compared with a plugged frame solution, there will be no sealing problems in the transitional area inside and no tolerance problems in the window frame area that might cause wind noise.
Steel and aluminum parts can be combined without any problem (hybrid construction).
The joint sealing can be integrated into fixing and sealing profiles, respectively.

The invention is explained and outlined in greater detail by the examples shown. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1a is a side view showing the outer plate and the connecting plate of the outer plate prior to joining;

FIG. 1b is a side view showing the outer plate and the connecting plate of the outer plate after joining;

FIG. 2a is a view showing the inner module, mainly comprised of the door inner plate, locking plate, and a reinforcement for the B-column, prior to assembly;

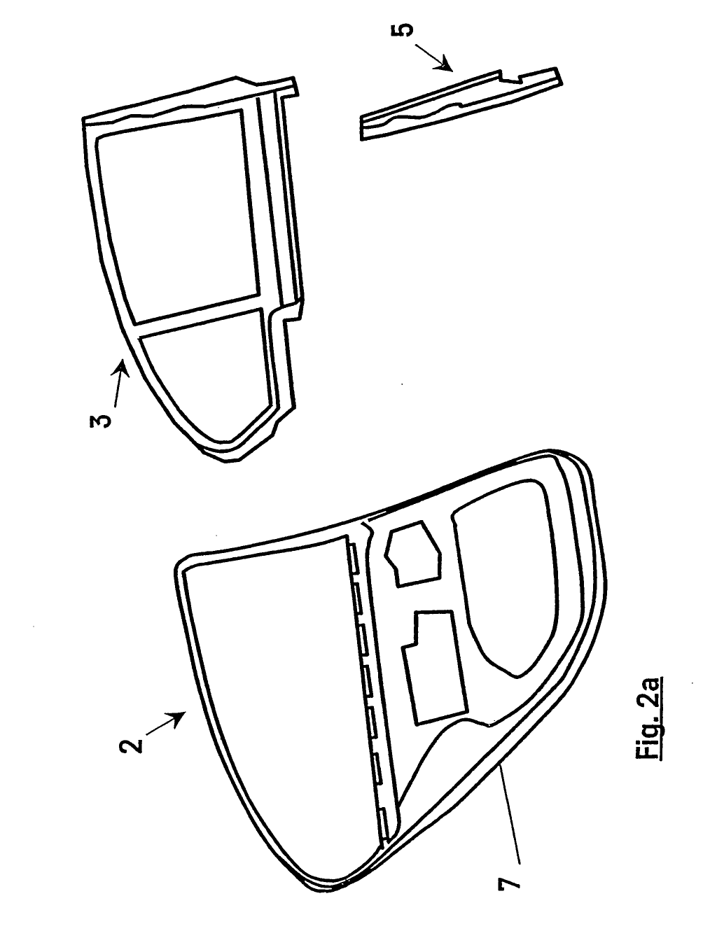

FIG. 2b is a view showing the inner module, mainly comprised of the door inner plate, locking plate, and a reinforcement for the B-column, prior to assembly;

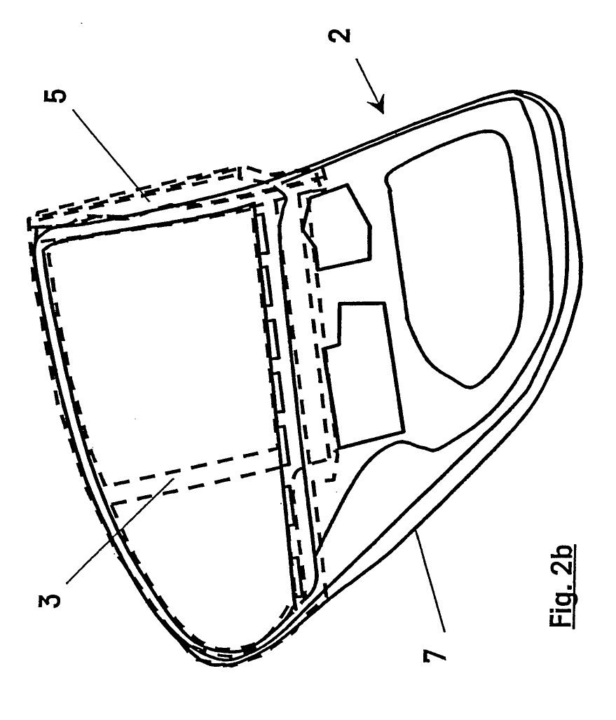

FIG. 3 is a view of the outer and inner module after assembly, with the outer module being represented in dashed lines;

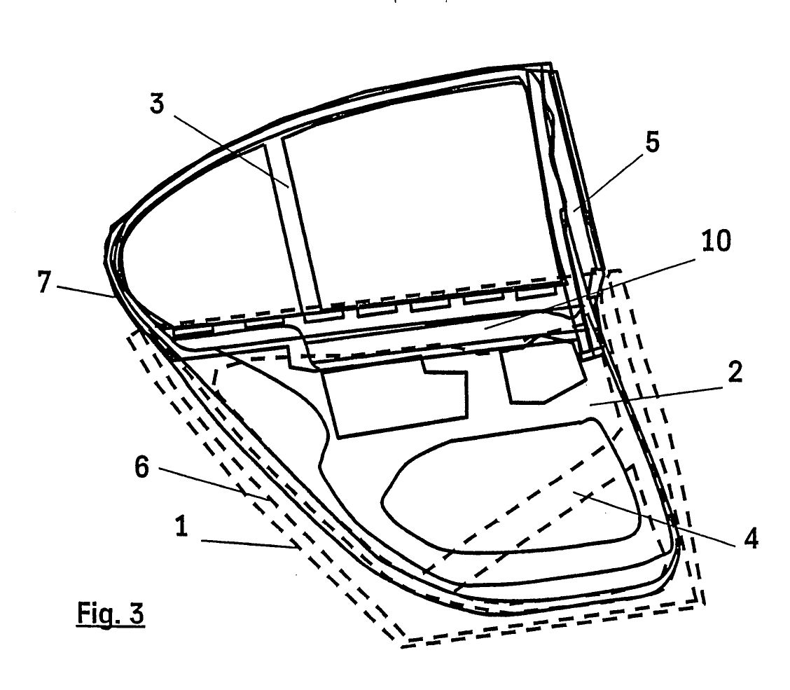

FIG. 4 is a view of the assembled door in accordance with FIG. 3, with the separation line between outer and inner module, in particular, being shown as a dotted line;

FIG. 5 is a view showing a section through the connection of the connecting plate of the outer module with the door inner plate of the inner module, including the door-side door seal;

FIG. 6 is a schematic view showing a flow diagram for the assembly sequence; and

FIG. 7 is a view showing the embodiment of a door representing state-of-art technology

### DESCRIPTION OF THE PREFERRED EMBODIMENTS

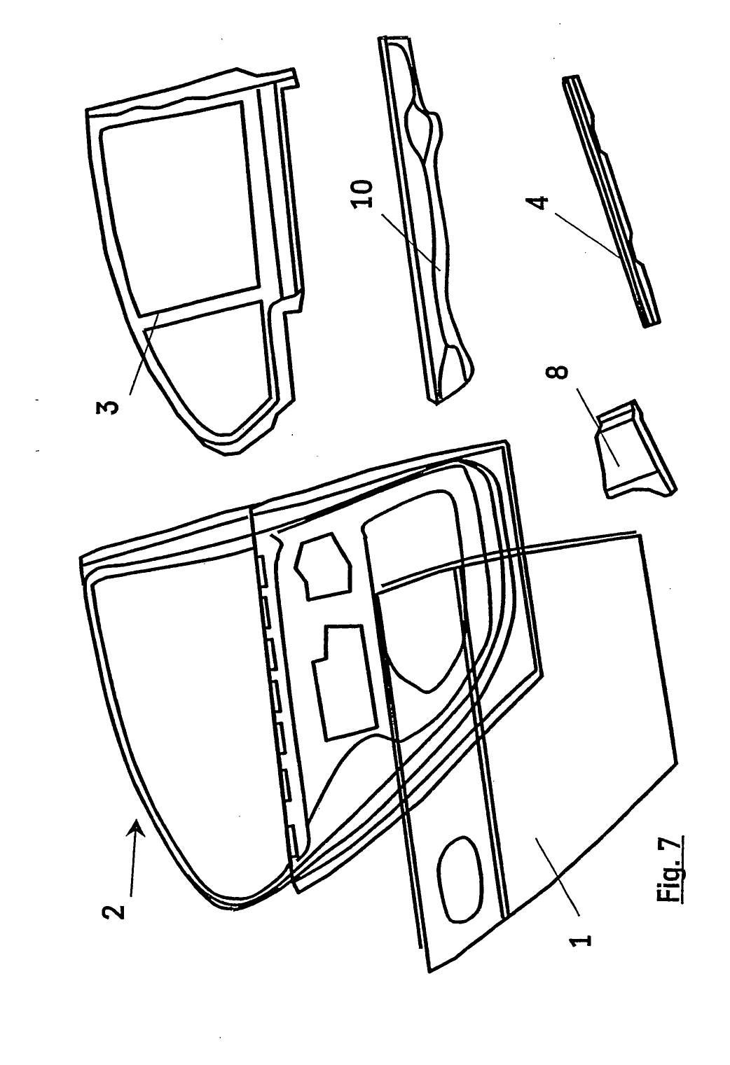

Referring to the drawings in particular, the component parts shown in FIG. 7, i.e. door outer plate 1, locking plate 3, reinforcement 4, reinforcement 8 for the door hinge, and reinforcing plate 10 for the area of the window shaft are mainly identical to the elements implemented with the door according to the present invention. Merely the door inner plate 2′ belonging to state-of-art technology is of a more stable configuration, having a substantial drawing depth in vehicle cross direction. The reinforcing parts 4, 8, and 10 are usually connected firmly to the door inner plate 2′, preferably by welding, while the door outer plate 1, in particularly, and mostly the locking plate 3, too, are connected by folding with the door inner plate 2′.

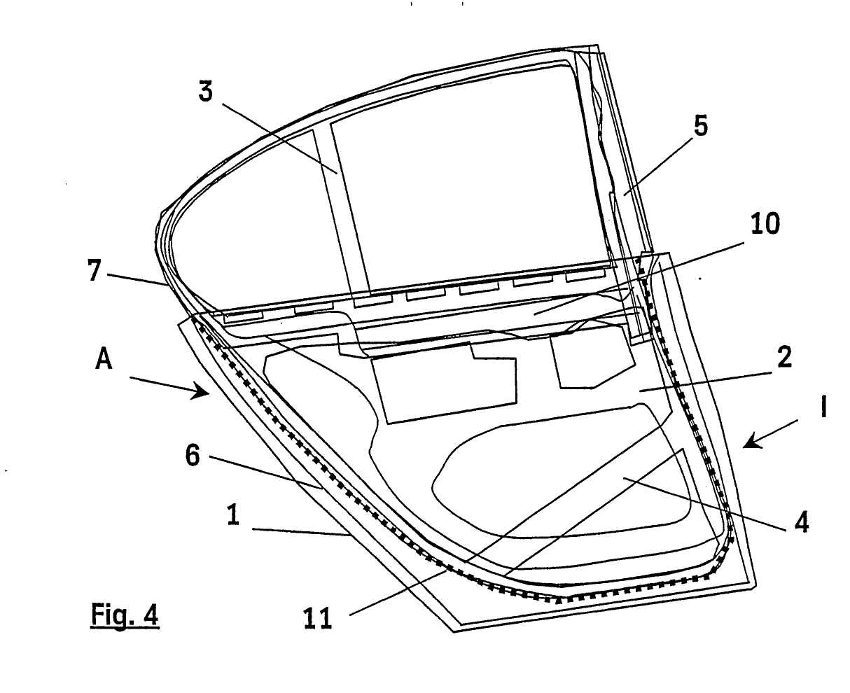

With the door according to the present invention, as compared therewith, the outer module and inner module are manufactured and/or joined separately from each other, with the separation line 11, as becomes evident from FIG. 4 in particular, extending between the outer module A and inner module I in an area that roughly lies at half the width of the original door inner plate 2′ viewed in vehicle cross direction. The door outer module A consists of a frame like connecting plate 6, whose frame extends at three sides along the sealing line and which in the upper area consists of the horizontal reinforcing plate 10 for the window shaft.

The inner module consists of the door inner plate 2, which as compared with state-of-art technology is relatively narrow, which is connected by laser welding or soldering to the locking plate 3 and reinforcement 5 for the B-column and which has a circumferential doorside door seal 7. In its interior, the door inner plate 2 has means to accommodate door aggregates; these means are not explained in greater detail hereunder.

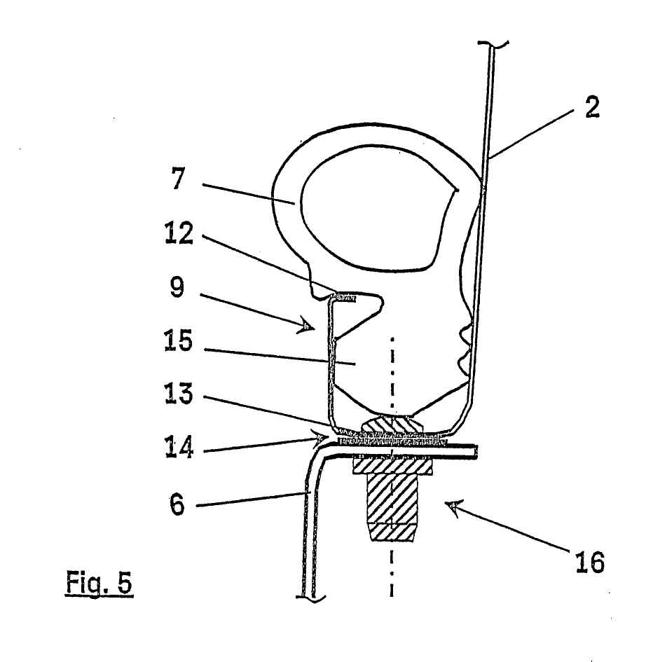

Shown in FIG. 5 is the special configuration of the fixing profile 9 affixed to the connecting plate 6 for the door seal 7 that can be plugged-on. The fixing profile is of a U-shaped configuration and it has a level and plane basic surface 13 for fastening the connecting plate 6 via a screwed connection 16 to the door inner plate 2. In addition, it is possible to place a glued connection 16 in between thereof The door seal 7 has a hollow profile for sealing towards the door frame. For permanent fixing of the door seal 7, a clamping part 15 is retained by the aid of rim 12 within the U-shaped fixing profile 9.

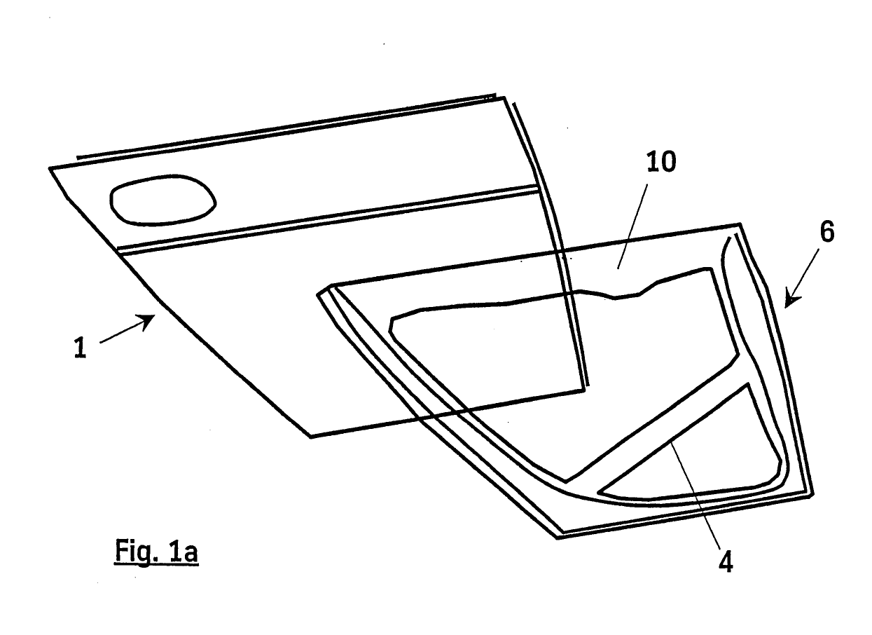

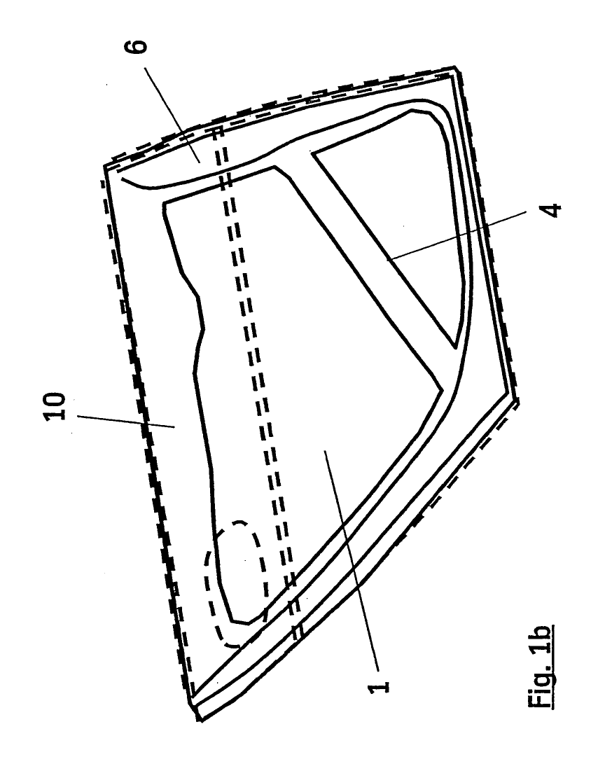

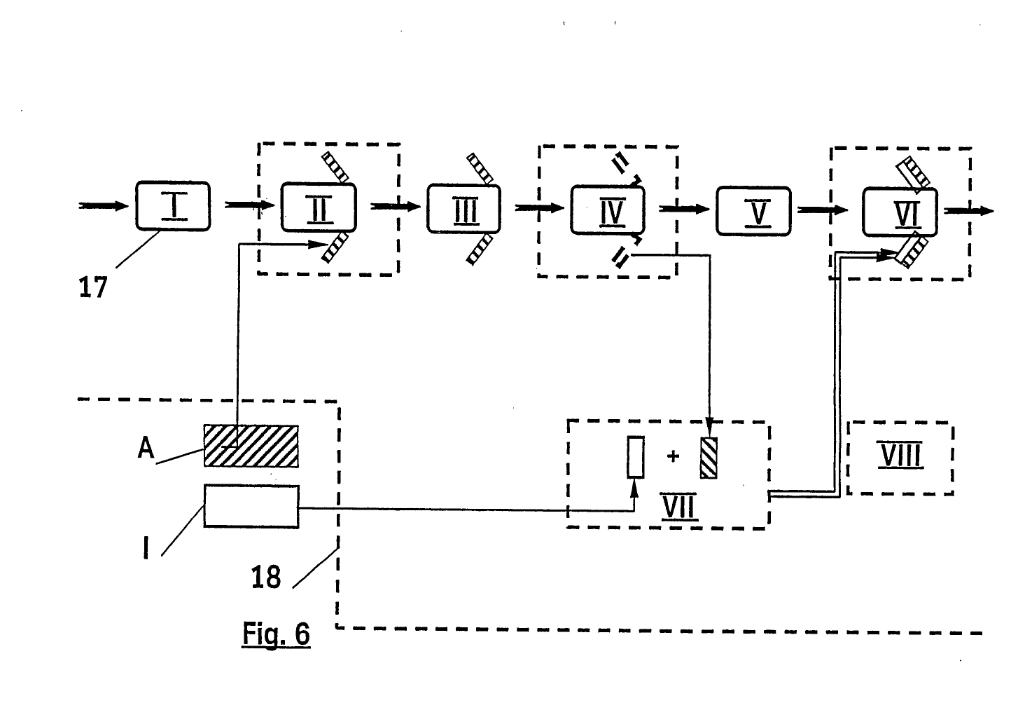

Schematically shown in FIG. 6 are various stations I through VIII for assembly of the door to a car body 17, which is transported on a conveyor facility. The usual assembly of the car body (framing) takes place in station I. In station II, the prefabricated outer module A (vide FIG. 1b) is screwed to the car body 17, with the hinges being adjusted and set there, too. In station HI, the car body 17 and the outer module A are lacquered jointly. Subsequently, in station IV, it is possible to separate the outer module A again from the car body 17 by separating the hinge and carrying it to station VII to assemble it with the inner module I delivered from external sources. In station V, the interior outfit can brought into car body 17 at the same time. After the outer module A and inner module I have been joined by a screw or rivet connection (vide FIG. 5), the circumferential door seal 7 is plugged onto fixing profile 9 in station VIII and finally the complete doors are mounted to the car body in station VI.

While specific embodiments of the invention have been shown and described in detail to illustrate the application of the principles of the invention, it will be understood that the invention may be embodied otherwise without departing from such principles.

1. A door for motor vehicles with a door outer plate and a door inner plate, the door comprising:
an outer module; and
an inner module, said outer module and said inner module can be connected to each other by screws, rivets, and adhesives or in a similar manners, said inner module having means for accommodating door aggregates including at least one of a window pane, side window handles, and a side airbag, said outer module being comprised of a door outer plate and a connecting plate affixed thereto, said connecting plate having integrated or retro-fittable reinforcing parts, said connecting plate carrying door hinges connectable to the car body in a detachable configuration said inner module being comprised of the door inner plate and at least a locking plate connectable thereto the door inner plate and said locking plate encompass a window frame the door inner plate having a circumferential fixing profile for a door seal that can be plugged-on, a separation line between said outer module and said inner module extending along a sealing plane of said door-side door seal.

2. A door pursuant to claim 1, wherein a circumferential fixing profile is formed by deep-drawing technique to the inner plate.

3. A door as claimed in claim 1, further comprising a circumferential fixing profile having a cross-section mainly configured like a U-shape and having a short, mainly rectangular rim bent towards the inside, said fixing profile being located at an outer end to retain said door seal.

4. A door as claimed in claim 3, wherein the U-shaped fixing profile has a level and plane support surface for connection with the connecting plate of the outer module.

5. A door pursuant to claim 4, wherein the connection of the fixing profile with the connecting plate is comprised of a screw or rivet connection and, additionally, of an adhesive connection.

6. A door pursuant to claim 1, wherein the door inner plate and said locking plate and said reinforcing plate for a vehicle B-column are connected with each other by laser welding or laser soldering.

7. A door pursuant to claim 1, wherein the outer module is lacquered jointly with the car body, and the inner module is lacquered separately thereof.

8. A door pursuant to claim 1, wherein said connecting plate of the outer module has a circumferential frame, which is profiled in its cross-section.

9. A door pursuant to claim 8, wherein said circumferential frame extends in a U-shape along the door seal and is comprised of a reinforcing plate, which is arranged in the area of a window shaft.
